(19) United States
(12) Patent Application Publication
(10) Pub. No.: US 2024/0343113 A1
(43) Pub. Date: Oct. 17, 2024

(54) SYSTEM AND METHOD FOR CONTROLLING TANDEM AXLE SHIFTING

(71) Applicant: Dana Heavy Vehicle Systems Group, LLC, Maumee, OH (US)

(72) Inventors: Jordan M. HOUSER, Sylvania, OH (US); James ALLEN, Atherstone (GB)

(21) Appl. No.: 18/299,513

(22) Filed: Apr. 12, 2023

(51) Int. Cl. B60K 23/08; B60K 17/36; B60L 15/20; F16D 48/06

(52) U.S. Cl. CPC B60K 23/0808; B60K 17/36; B60L 15/2054; F16D 48/06; B60K 2023/0816; F16D 2500/10412; F16D 2500/1064; F16D 2500/3027; F16D 2500/3065; F16D 2500/30806

(57) ABSTRACT

Methods and systems for controlling shifting of a tandem axle assembly are described. In one example, a method comprises adjusting torque applied at an input connection of a first axle of a tandem axle assembly based on a clutch disengagement torque while transitioning the first axle between shift settings.

### TECHNICAL FIELD

The present disclosure relates to a system and method for a tandem axle assembly of a vehicle. The system and method may be applied to electrified tandem axles.

### BACKGROUND AND SUMMARY

Heavy trucks may include tandem axles to increase load carrying capacity and traction. Tandem axles are commonly driven via two shafts, such as a first drive shaft that extends from a propulsion source to a first axle and a second drive shaft that extends from the first axle to a second axle of the tandem axles. However, in an effort to reduce vehicle emissions, electrified tandem axles have been developed. An electrified axle of a tandem axle assembly (e.g., an axle that includes an electric propulsion source) may include an electric machine as a propulsion source. The electric machine may be coupled to a gearbox, with the gearbox configured to operate at different gear ratios in order to provide torque from the electric machine to the axle, and a clutch may connect the gearbox to the axle. The clutch may be configured such that force applied to the clutch, such as backrake applied to gear teeth of the clutch, maintains engagement of the clutch with the axle. As the amount of torque applied to the axle through the clutch increases, the force applied to maintain engagement of the clutch with the axle also increases.

Because the force applied to maintain engagement of the clutch with the axle is based on the amount of torque applied to the axle through the clutch, during a shift event, residual forces applied to the clutch by other components and/or features of the system may increase a difficulty of disengaging the clutch from the axle. For example, bearing drag, lubricant viscosity, and/or churning of lubricant at the clutch may result in additional torque applied to the clutch even during conditions in which torque is not provided to the clutch through the gearbox, which may maintain undesired engagement of the clutch with the axle during conditions in which the clutch is commanded to disengage from the axle. As a result, shift response time may be extended (e.g., a duration to adjust the shift setting of the axle may be increased), which may affect vehicle performance.

The inventors herein have recognized the abovementioned issues and have developed a system and method for a tandem axle assembly of a vehicle, comprising: during a shift event of a tandem axle assembly including a first axle and a second axle: reducing torque applied at the first axle while concurrently increasing torque applied at the second axle; and oscillating the reduced torque applied at the first axle while maintaining the increased torque applied at the second axle.

By reducing the torque applied at the first axle, increasing the torque applied at the second axle, and oscillating the torque at the first axle, it may be possible to provide the technical result of disengaging the clutch during the shift event with a reduced amount of force. For example, an actuator of the clutch may be configured to engage and/or disengage the clutch during the shift event. By oscillating the torque at the first axle, residual forces applied to the clutch by bearing drag, lubrication churning, etc. may be more easily overcome by the actuator such that the actuator may disengage the clutch with a reduced amount of force. As a result, shift response time may be shortened, which may increase vehicle performance, and less load may be applied to shift components, which may increase a durability of shift components and facilitate manufacture of the shift components with less thickness, reinforcement, etc., which may reduce a cost of the system. Further, by increasing the torque applied at the second axle while reducing the torque applied at the first axle the overall torque applied through the tandem axle assembly to propel the vehicle may be maintained throughout the shift event, which may further increase vehicle performance and/or driver comfort.

It may be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic representation of a vehicle including a tandem axle assembly that may be operated as described herein.

FIG. 2 shows a graph illustrating torque demand of a first axle and a second axle of a tandem axle assembly during a shift event.

FIG. 3 shows an example vehicle operating sequence according to the methods of FIGS. 5-6.

FIG. 4 shows enlarged views of portions of the graph of FIG. 3.

FIG. 5 shows a method for operating a vehicle including a tandem axle assembly.

FIG. 6 shows a method for controlling torque applied to axles of a tandem axle assembly during a shift event.

### DETAILED DESCRIPTION

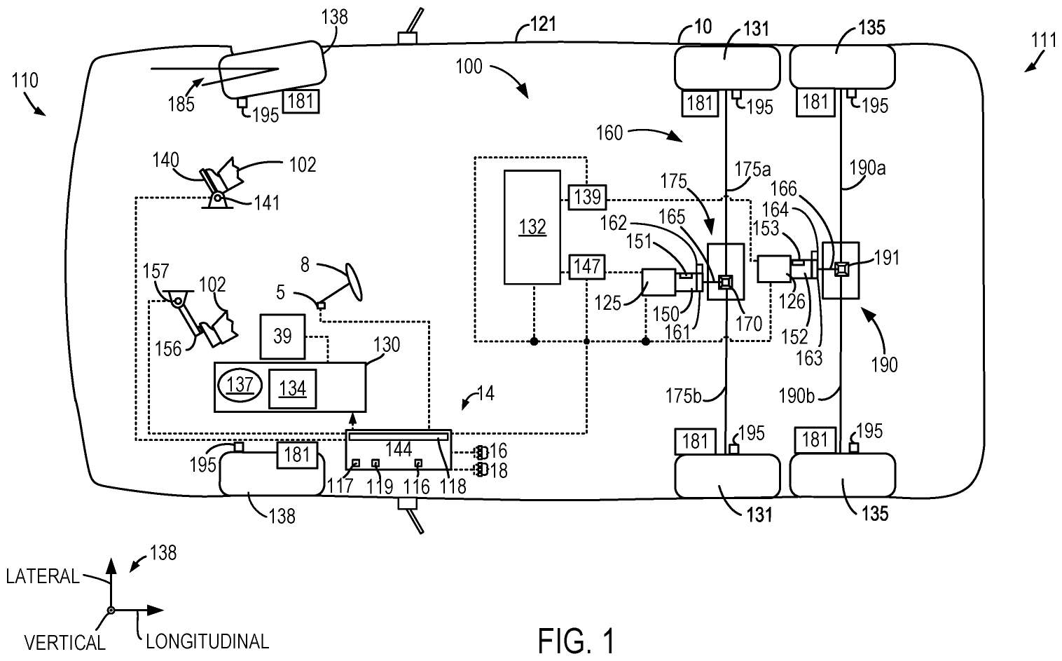

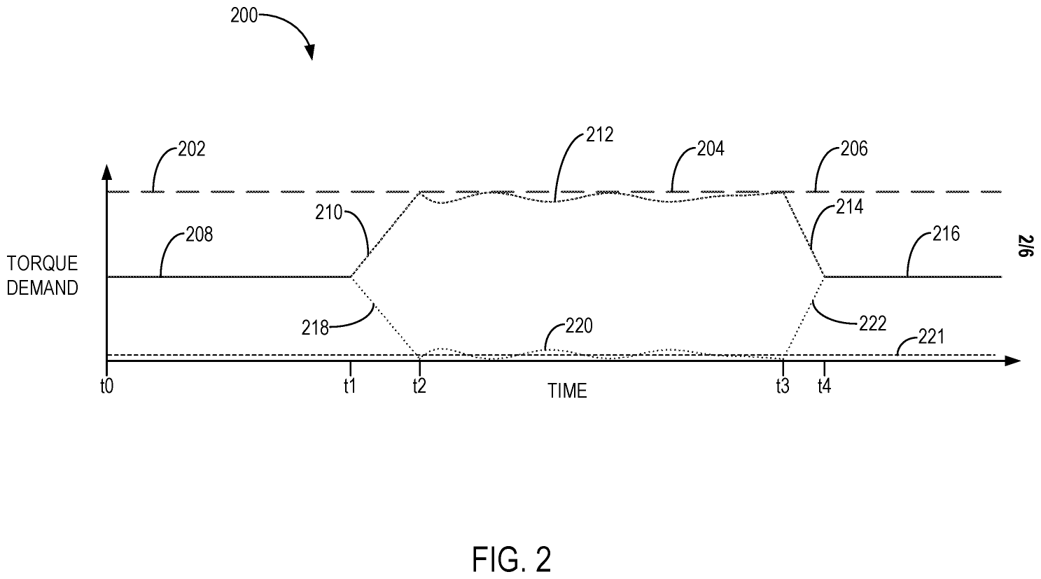

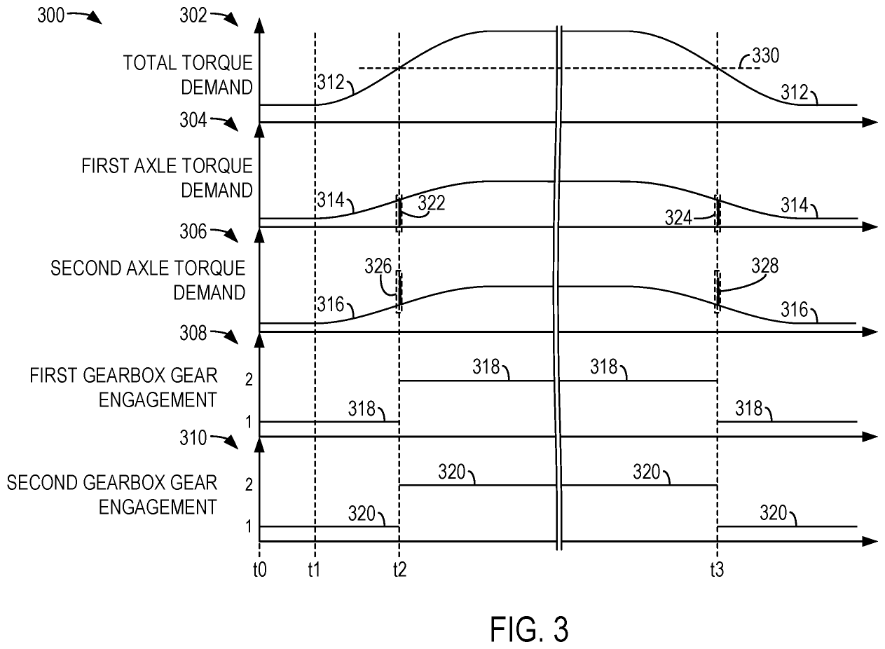

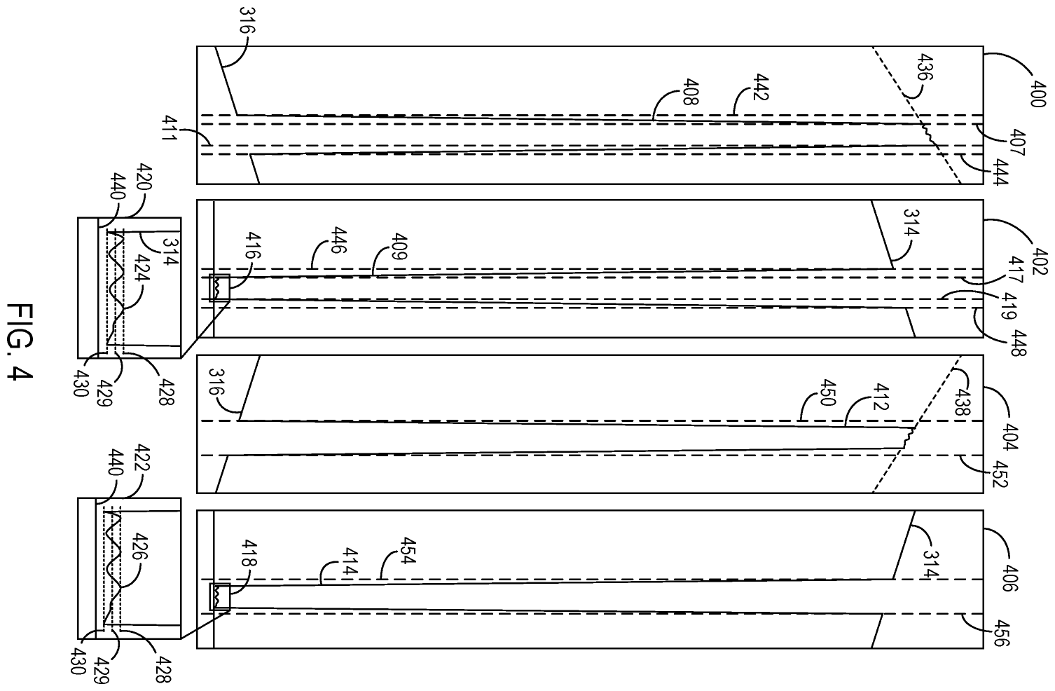

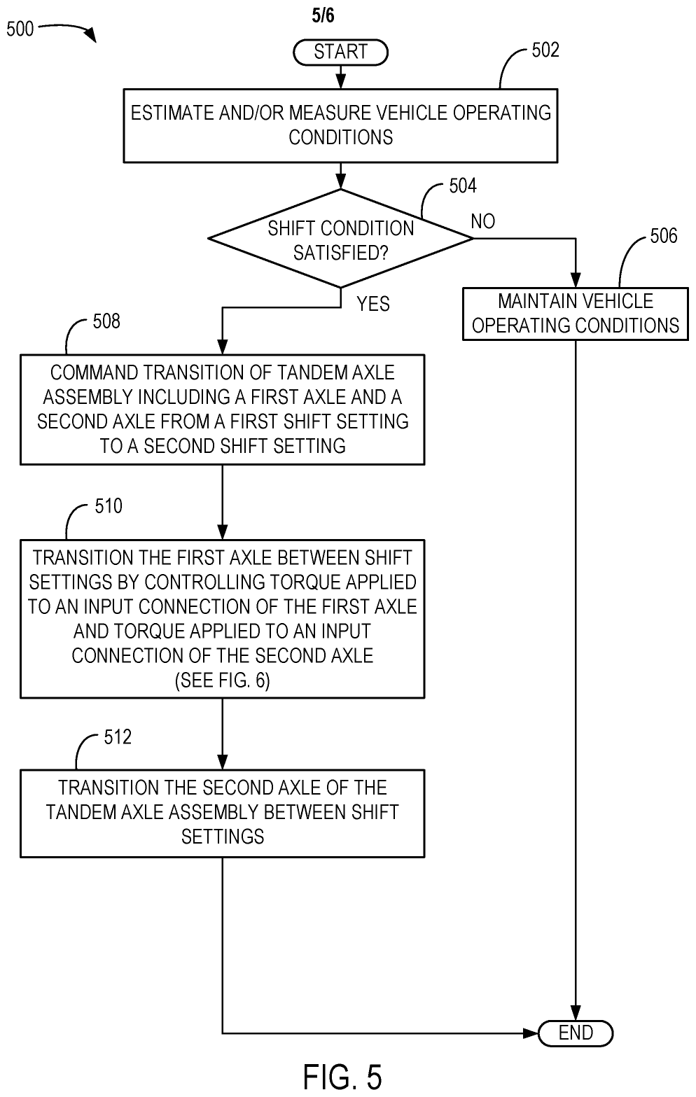

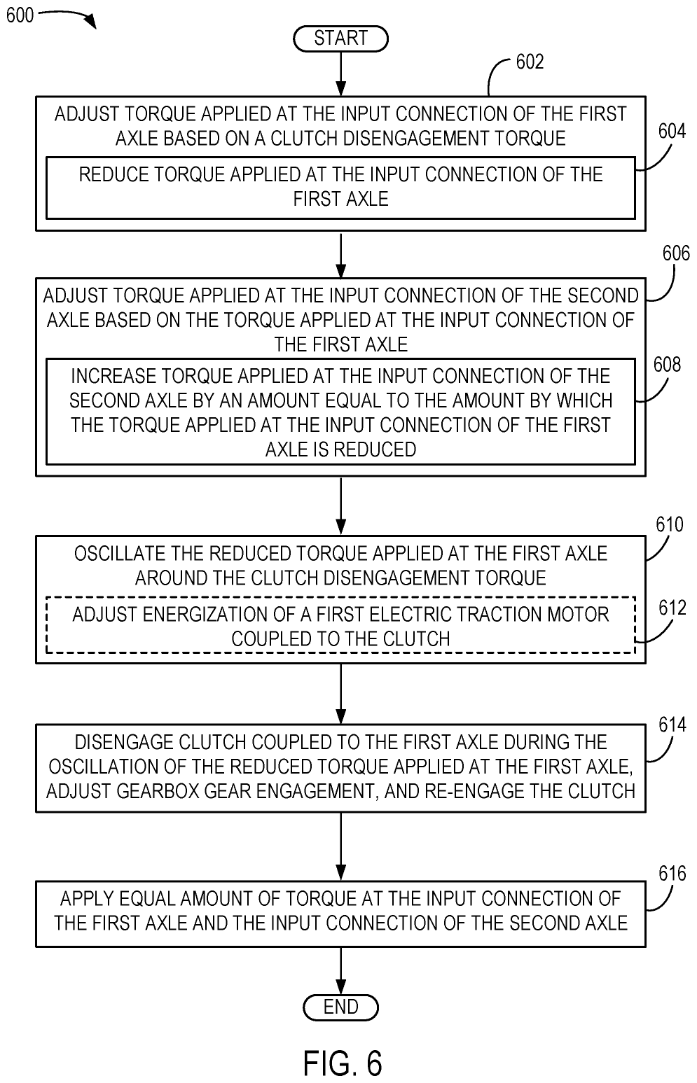

A vehicle may include a tandem axle assembly to increase a vehicle's load capacity and improve vehicle traction. In an effort to reduce emissions, some vehicle axles have been electrified so that a propulsion force may be provided via an electric machine that is integrated into the axle. Tandem electrified axle assemblies may include two electric machines, one for each axle, as shown in FIG. 1. The tandem axle assembly may be operated as shown in the sequence of FIG. 2 in response to satisfaction of a shift condition. According to the methods shown by FIGS. 5-6, during conditions in which a shift condition is satisfied, a shift setting of each axle of the tandem axle assembly may be adjusted during the shift event, as shown by FIG. 3. During the adjustment, torque applied at a first axle of the tandem axle assembly may be reduced, and torque applied at a second axle of the tandem axle assembly may be increased, as shown by FIG. 4. The reduction of torque at the first axle may be equal to the increase of torque at the second axle to maintain the overall torque applied through the tandem axle assembly for propulsion of the vehicle. Following reduction of the torque applied at the first axle, the torque applied at the first axle may be oscillated around a clutch disengagement torque in order to increase a speed of disengagement of the clutch to perform the adjustment of the shift setting of the first axle. The overall torque provided via the tandem axle assembly to propel the vehicle may be maintained throughout an entirety of the shift event, and the shift setting of each axle may be adjusted with an increased speed and reduced amount of actuator force. As a result, vehicle performance and driver comfort may be increased, clutch actuator wear may be reduced, and/or the clutch actuators may be configured with a smaller size which may reduce manufacturing costs of the system.

Referring to FIG. 1, an example vehicle 121 that includes an electrified tandem axle assembly 160 is shown. The electrified tandem axle assembly 160 operates as a propulsion system for vehicle 121. The tandem axle assembly 160 may be referred to herein as a tandem axle assembly and/or tandem axle system. Throughout the description of FIG. 1, mechanical connections between various components are illustrated as solid lines, whereas electrical connections between various components are illustrated as dashed lines.

The vehicle 121 includes a front portion 110 and a rear portion 111. Vehicle 121 includes front wheels 138, a first pair of rear wheels 131, and a second pair of rear wheels 135. Tandem axle assembly 160 includes two propulsion sources, including a first electric machine 125 (which may be referred to herein as a front electric machine, first electric motor, and/or first electric traction motor) and a rear electric machine 126 (which may be referred to herein as a rear electric machine, second electric motor, and/or second electric traction motor). Electric machines 125 and 126 may consume or generate electrical power depending on their operating mode, in some examples. Vehicle 121 includes a first electric machine 125 (e.g., a propulsion source) that may selectively provide propulsive effort (e.g., driving torque) to tandem axle assembly 160. In particular, first electric machine 125 is shown mechanically coupled to first gearbox 150 including a plurality of gears 151, and first gearbox 150 is mechanically coupled to a first axle 175 of tandem axle assembly 160 (which may be referred to herein as a front axle of the tandem axle assembly 160). First electric machine 125 may provide mechanical power to first gearbox 150 (e.g., first electric machine 125 may be coupled to first gearbox 150 via a shaft and may be energized to rotate the shaft, where rotation of the shaft applies torque to one or more of the gears 151 of the first gearbox 150). Front axle 175 may receive mechanical power (e.g., driving torque) from first gearbox 150 via driveshaft 165 so that mechanical power may be transmitted to rear wheels 131. Front axle 175 may also be comprised of two half shafts, including a first half shaft 175a (which may be referred to herein as a right half shaft) and a second half shaft 175b (which may be referred to herein as a left half shaft). The first half shaft 175a and second half shaft 175b may be arranged coaxially (e.g., the first half shaft 175a and second half shaft 175b may be arranged along a same, shared rotational axis). The front axle 175 may be an integrated axle that includes a front axle differential gear set 170 (which may be referred to herein as a final drive).

Further, the second electric machine 126 may provide propulsive effort to tandem axle assembly 160. The second electric machine 126 is shown mechanically coupled to second gearbox 152 including a plurality of gears 153, and second gearbox 152 is mechanically coupled to a rear axle 190 of the tandem axle assembly 160 (which may be referred to herein as a second axle of the tandem axle assembly 160). Second electric machine 126 may provide mechanical power to second gearbox 152. Rear axle 190 may receive mechanical power from second gearbox 152 via driveshaft 166 so that mechanical power may be transmitted to rear wheels 135. Rear axle 190 may comprise two half shafts, including a first haft shaft 190a (which may be referred to herein as a right half shaft) and a second half shaft 190b (which may be referred to herein as a left half shaft). The rear axle 190 may be an integrated axle that includes a rear axle differential gear set 191 (which may be referred to herein as a final drive).

Electric machines 125 and 126 are electrically coupled to and may receive electrical power from onboard electrical energy storage device 132. Furthermore, electric machines 125 and 126 may provide a generator function to convert the vehicle's kinetic energy into electrical energy, where the electrical energy may be stored at electric energy storage device 132 for later use by the electric machine 125 and/or electric machine 126. A first inverter system controller (ISC1) 139 may convert alternating current generated by second electric machine 126 to direct current for storage at the electric energy storage device 132 and vice versa. A second inverter system controller (ISC2) 147 may convert alternating current generated by first electric machine 125 to direct current for storage at the electric energy storage device 132 and vice versa. Electric energy storage device 132 may be a battery, capacitor, inductor, or other electric energy storage device.

In some examples, electric energy storage device 132 may be configured to store electrical energy that may be supplied to other electrical loads residing on-board the vehicle (other than the motor), including cabin heating and air conditioning, engine starting, headlights, cabin audio and video systems, etc.

The vehicle 121 includes an electronic controller 144 (which may be referred to herein as the controller, vehicle controller, tandem axle controller, etc.). Controller 144 may communicate (e.g., communicate electronically via a direct electronic connection, wireless electronic connection, etc.) with one or more of electric machine 125, electric machine 126, first inverter system controller 139, second inverter system controller 147, and energy storage device 132 via a controller area network Controller 144 may receive sensory feedback information (e.g., receive electronic signals) from one or more of electric machine 125, electric machine 126, first inverter system controller 139, second inverter system controller 147, energy storage device 132, etc. Further, controller 144 may send control signals (e.g., transmit electronic control signals) to one or more of electric machine 125, electric machine 126, first inverter system controller 139, second inverter system controller 147, energy storage device 132, etc., based on (e.g., responsive to) the sensory feedback information. Controller 144 may receive an indication of an operator requested output (e.g., driver demand, torque demand, etc.) of the vehicle propulsion system from a human operator 102, or an autonomous controller. For example, controller 144 may receive sensory feedback from driver demand pedal position sensor 141 which may communicate with pedal 140 (e.g., pedal position sensor 141 may measure a position of pedal 140 and may communicate electronically with the controller 144 based on the pedal position). Pedal 140 may refer schematically to a driver demand pedal. Similarly, controller 144 may receive an indication of an operator requested vehicle braking via a human operator 102, or an autonomous controller. For example, control system 14 may receive sensory feedback from pedal position sensor 157 which communicates with brake pedal 156. Controller 144 may provide vehicle braking solely via electric machines 125 and 126, solely via friction foundation brakes 181 (e.g., brake pads and rotors), or via a combination of electric machines 125 and 126 and friction foundation brakes 181. The vehicle braking torque that may be applied by electric machines 125 and 126 and the friction foundation brakes may be based on a braking torque amount that is requested via brake pedal 156. Controller 144 may also receive a signal from steering angle sensor 5 which monitors a position of steering wheel 8 to provide an estimate of steering angle 185. Steering angle 185 is an angle of front wheels 138 relative to a position where front wheels 138 cause vehicle 121 to travel in a straight direction.

Energy storage device 132 may periodically receive electrical energy from a power source such as a stationary power grid (not shown) residing external to the vehicle (e.g., not part of the vehicle). As a non-limiting example, vehicle propulsion system 100 may be configured as a plug-in electric vehicle (EV), whereby electrical energy may be supplied to energy storage device 132 via the power grid (not shown).

One or more wheel speed sensors (WSS) 195 may be coupled to one or more wheels of vehicle propulsion system 100. The wheel speed sensors may detect rotational speed of each wheel. Such an example of a WSS may include a permanent magnet type of sensor.

Controller 144 may receive information from a plurality of sensors 16 (various examples of which are described herein) and may send control signals to a plurality of actuators 181 (various examples of which are described herein). As one example, sensors 16 may include tire pressure sensor(s) (not shown), wheel speed sensor(s) 195, etc. In some examples, sensors associated with electric machine 125, electric machine 126, wheel speed sensor 195, etc., may communicate information (e.g., transmit electronic signals) to controller 144, regarding various states of electric machine operation. Controller 144 may include non-transitory memory 117 (e.g., read only memory), random access memory 119, digital inputs/outputs 118, and a microcontroller 116.

Vehicle 121 may also include an on-board navigation system 39 (for example, a Global Positioning System) on dashboard 130 that an operator of the vehicle may interact with. The navigation system 39 may include one or more location sensors for assisting in estimating a location (e.g., geographical coordinates) of the vehicle. For example, on-board navigation system 39 may receive signals from GPS satellites (not shown), and may identify the geographical location of the vehicle based on the received signals. In some examples, the geographical location coordinates may be communicated to controller 144.

Dashboard 130 may further include a display system 137 configured to display information to the vehicle operator. Display system 137 may comprise, as a non-limiting example, a touchscreen, or human machine interface (HMI), display which enables the vehicle operator to view graphical information as well as input commands. In some examples, display system 137 may be connected wirelessly to the internet (not shown) via controller (e.g. 144). As such, in some examples, the vehicle operator may communicate via display system 137 with an internet site or software application (app).

Dashboard 130 may further include an operator interface 134 via which the vehicle operator may adjust the operating status of the vehicle. Specifically, the operator interface 134 may be configured to initiate and/or terminate operation of the vehicle driveline (e.g., electric machine 125 and electric machine 126) based on an operator input. Various examples of the operator interface 134 may include interfaces that provide a physical apparatus, such as an active key, that may be inserted into the operator interface 134 to start the electric machines 125 and 126 and to turn on the vehicle, or may be removed to shut down the electric machines 125 and 126 to turn off the vehicle. Other examples may include a passive key that is communicatively coupled to the operator interface 134. The passive key may be configured as an electronic key fob or a smart key that does not have to be inserted or removed from the operator interface 134 to operate the vehicle electric machines 125 and 126. Rather, the passive key may need to be located inside or proximate to the vehicle (e.g., within a threshold distance of the vehicle). Still other examples may additionally or optionally use a start/stop button that is manually pressed by the operator to start or shut down the electric machines 125 and 126 to turn the vehicle on or off. In other examples, a remote electric machine start may be initiated remote computing device (not shown), for example a cellular telephone, or smartphone-based system where a user's cellular telephone sends data to a server and the server communicates with the vehicle controller 144 to start the engine.

The electronic controller 144 may control operation of first gearbox 150 and second gearbox 152. For example, the electronic controller 144 may adjust a shift setting of one or both of the axles of the tandem axle assembly 160 based on vehicle operating conditions such as vehicle speed, vehicle load, vehicle terrain, etc. Adjusting the shift setting of an axle, such as first axle 175, may include adjusting engagement of a clutch coupled to the axle, such as first clutch 161. In the example of the first axle 175, the first clutch 161 may be engaged to couple the first axle 175 to the first gearbox 150. Engagement of the first clutch 161 may be adjusted by the controller via signals (e.g., electronic signals) transmitted to an actuator 162 of the first clutch 161 by the controller 144. Adjusting the shift setting of the first axle 175 may further include adjusting the operating gear ratio of the first gearbox 150. For example, the controller 144 may communicate electronically with the first gearbox 150 in order to command the first gearbox 150 to adjust the operating gear ratio (e.g., the controller 144 may provide a command to an actuator of the first gearbox 150 in order to adjust gear engagement of gears within the first gearbox 150 to change the operating gear ratio of the first gearbox 150). The first gearbox 150 may operate with a variety of different operating gear ratios, with the controller 144 selecting the operating gear ratio based on the vehicle operating conditions. The first gearbox 150 may provide torque to the first axle 175 while operating at a variety of different gear ratios, and transitioning from providing torque to the first gearbox 150 while operating at a first gear ratio to providing torque to the first gearbox 150 while operating at a second gear ratio may be referred to herein as shifting the first axle 175. Although the first gearbox 150 and the first axle 175 are described above by way of example, the second gearbox 152 and second axle 190 may be controlled similarly by the controller 144. The controller 144 may command each of the first gearbox 150 and the second gearbox 152 to transition from operating with a first gear ratio to operating with a second gear ratio, which may be referred to herein as shifting the tandem axle assembly and/or a shift event of the tandem axle assembly.

The shift setting of an axle as described herein refers to the gear ratio at which the axle is driven via a respective gearbox. For example, during conditions in which the first axle 175 is driven by torque provided through the first gearbox 150 with the first gearbox 150 operating with a first gear ratio (e.g., with a first set of gears of the first gearbox 150 engaged such that the first gearbox 150 outputs torque with the first gear ratio), the first axle 175 may be referred to as operating with a first shift setting (e.g., wherein the first shift setting corresponds to the first gear ratio of the first gearbox 150). During conditions in which the first axle 175 is driven by torque provided through the first gearbox 150 with the first gearbox 150 operating with a second gear ratio (e.g., with a second set of gears of the first gearbox 150 engaged such that the first gearbox 150 outputs torque with the second gear ratio), the first axle 175 may be referred to as operating with a second shift setting (e.g., wherein the second shift setting corresponds to the second gear ratio of the first gearbox 150). Although two shift settings are described above as an example, additional shift settings may be possible (e.g., a third shift setting corresponding to a third gear ratio of the first gearbox 150, a fourth shift setting corresponding to a fourth gear ratio of the first gearbox 150, etc.).

Further, although the shift settings of the first axle 175 are described above for example, the second axle 190 may be referred to in a similar way. For example, the second axle 190 may have a first shift setting corresponding to a first gear ratio of the second gearbox 152, a second shift setting corresponding to a second gear ratio of the second gearbox 152, etc. During a shift event of the tandem axle assembly 160, each of the first axle 175 and the second axle 190 may be adjusted to a same shift setting (e.g., prior to the shift event, the first axle 175 and the second axle 190 may be operating with the first shift setting, and during the shift event, the first axle 175 and the second axle 190 may be adjusted to operating with the second shift setting). The first shift setting of the first axle 175 and the first shift setting of the second axle 190 may each refer to a same gear ratio of the corresponding gearboxes. For example, during conditions in which the first axle 175 is operating with the first shift setting, torque may be provided to the first axle 175 through the first gearbox 150 operating at a first gear ratio, and during conditions in which the second axle 190 is operating with the first shift setting, torque may be provided to the second axle 190 through the second gearbox 152 operating at the first gear ratio, with the first gear ratio of the first gearbox 150 being equal to the first gear ratio of the second gearbox 152. The first gearbox 150 and the second gearbox 152 may be configured similarly such that the first gear ratio of the first gearbox 150 is equal to the first gear ratio of the second gearbox 152, the second gear ratio of the first gearbox 150 is equal to the second gear ratio of the second gearbox 152, and so forth.

Each of the gearboxes (e.g., first gearbox 150 and second gearbox 152) may be coupled to a respective clutch, where the respective clutches may connect the gearboxes to the respective axles. For example, first gearbox 150 may be coupled to first clutch 161, and the first clutch 161 may be engaged to connect the first gearbox 150 to the first axle 175. While the first clutch 161 is engaged, torque generated by the first electric motor 125 may be provided to the first axle 175 through the first gearbox 150 and the first clutch 161. The second gearbox 152 may be coupled to a second clutch 163, and the second clutch 163 may be engaged to connect the second gearbox 152 to the second axle 190. While the second clutch 163 is engaged, torque generated by the second electric motor 126 may be provided to the second axle 190 through the second gearbox 152 and the second clutch 163. In some examples, each of the first clutch 161 and the second clutch 163 may be a dog clutch. The first clutch 161 may be coupled to a first actuator 162 configured to adjust an engagement of the first clutch 161 (e.g., engage the first clutch 161 with the first axle 175 and/or disengage the first clutch 161 from the first axle 175) responsive to signals (e.g., electronic signals) provided (e.g., transmitted) to the first actuator 162 by the controller 144. The second clutch 163 may be coupled to a second actuator 164 configured to adjust an engagement of the second clutch 163 (e.g., engage the second clutch 163 with the second axle 190 and/or disengage the second clutch 163 from the second axle 190) responsive to signals provided to the second actuator 164 by the controller 144.

The first clutch 161 may be configured to be maintained in engagement with the first axle 175 during conditions in which the first clutch 161 is not commanded to disengage from the first axle 175 by the controller 144. As one example, the first clutch 161 may be biased into engagement with the first axle 175 by a first biasing element or other feature configured to apply force to the first clutch 161, and the force applied to the first clutch 161 by the first biasing element or other feature may be based on the amount of torque provided to the first axle 175 through the first clutch 161. For example, the force applied to the first clutch 161 by the first biasing element or other feature may be proportional to the amount of torque provided to the first axle 175 through the first clutch 161. Similarly, the second clutch 163 may be configured to be maintained in engagement with the second axle 190 during conditions in which the second clutch 163 is not commanded to disengage from the second axle by the controller 144. As one example, the second clutch 163 may be biased into engagement with the second axle 190 by a second biasing element or other feature configured to apply force to the second clutch 163, and the force applied to the second clutch 163 by the second biasing element or other feature may be based on the amount of torque provided to the second axle 190 through the second clutch 163. As another example, the second clutch 163 may be biased into engagement with the second axle 190 via a tapered gear profile of gears of the second clutch 163 and/or second axle 190 (e.g., gears of the second clutch 163 and/or second axle 190 may be shaped to bias the second clutch 163 into engagement with the second axle 190).

The controller 144 may initiate a shift event of the tandem axle assembly 160 responsive to vehicle operating conditions. For example, during conditions in which a speed of the vehicle exceeds a threshold speed, the controller 144 may command adjustment of the shift settings of the axles of the tandem axle assembly 160 (e.g., to adjust the gear ratio of the respective gearboxes through which the axles are provided torque). Although vehicle speed is provided as one example vehicle operating condition that may be monitored by the controller 144 in order to determine whether a shift condition has been satisfied (with the shift event of the tandem axle assembly occurring responsive to the determination at the shift condition is satisfied), the controller 144 may initiate a shift event based on other vehicle operating conditions, in some examples, such as wheel torque, vehicle terrain, vehicle load, etc.

The controller 144 may further control which axle of the tandem axle assembly is to be adjusted first during the shift event. For example, during some conditions, the controller 144 may initiate a shift event of the tandem axle assembly 160 and may command adjustment of the shift setting of the first axle 175 to occur prior to adjustment of the shift setting of the second axle 190 during the shift event. During other conditions, the controller 144 may initiate a shift event of the tandem axle assembly 160 and may command adjustment of the shift setting of the second axle 190 to occur prior to adjustment of the shift setting of the first axle 175 during the shift event. The determination of whether the shift setting of the first axle 175 is adjusted prior to the shift setting of the second axle 190 during a given shift event, or whether the shift setting of the second axle 190 is adjusted prior to the shift setting of the first axle 175 during the shift event, may be based on a torque capacity of the first axle and a torque capacity of the second axle. As one example, the first axle may have a higher, first torque capacity, and the second axle may have a lower, second torque capacity. Due to the torque capacity of the first axle being higher than the torque capacity of the second axle, the controller 144 may adjust the shift setting of the first axle prior to adjusting the shift setting of the second axle because an efficiency of operating the first axle with the adjusted shift setting may be higher than an efficiency of operating the second axle with the adjusted shift setting. However, in other examples, the second axle may have a higher torque capacity than the first axle, and the controller 144 may adjust the shift setting of the second axle prior to adjusting the shift setting of the first axle.

In the configuration of the system as described above, the controller 144 may control operation of the tandem axle assembly 160 according to the methods described below. In particular, the controller 144 may control the amount of torque provided to each axle during a shift event according to the methods described below, which may result in increased shifting speed, reduced torque losses, reduced actuator wear, etc.

Referring to FIG. 2, a graph 200 is shown illustrating an example operating sequence of a vehicle including a tandem axle assembly. In some examples, the vehicle may be similar to, or the same as, the vehicle 121 described above with reference to FIG. 1, and the tandem axle assembly may be similar to, or the same as, the tandem axle assembly 160 shown by FIG. 1 and described above. The operating sequence of the vehicle shown by the graph 200 of FIG. 2 may result from implementation of the methods of FIGS. 5-6 as described further below.

The graph 200 shows torque demand of a first axle and a second axle of the tandem axle assembly the vehicle. The first axle and the second axle may be similar to, or the same as, the first axle 175 and the second axle 190, respectively, described above with reference to FIG. 1. The vertical axis of the graph 200 indicates torque demand, and the horizontal axis of the graph 200 indicates time. The graph includes markers t0, t1, t2, t3, and t4 indicating times of interest, as described further below.

In the graph 200, an overall torque demand (e.g., total torque demand) of the tandem axle assembly is indicated by plot 202, plot 204, and plot 206, with the plot 202 occurring between time t0 and time t2, with the plot 204 occurring between time t2 and time t3, and with the plot 206 occurring at time t3 and onward. The overall torque demand represents the sum of the torque demand of the first axle and the torque demand of the second axle. The overall torque demand is the commanded torque output of the tandem axle assembly, as commanded by the electronic controller of the vehicle. The electronic controller may be similar to, or the same as, the electronic controller 144 described above with reference to FIG. 1. Although torque demand as indicated by the graph 200, in some examples the indicated torque demand may represent an actual torque output of the tandem axle assembly. For example, plot 202 may indicate an actual torque output of the tandem axle assembly, with the actual torque output including a first amount of torque provided by the first axle and a second amount of torque provided by the second axle.

In the example shown, plot 208 indicates torque demand of each of the first axle and the second axle of the tandem axle assembly. In particular, between time to and time t1, the torque demand of the first axle is equal to the torque demand of the second axle, as indicated by the non-divergence of the plot 208 between time t0 and time t1. The combined torque demand of the first axle and the second axle is equal to the overall torque demand indicated by plot 202 (e.g., between time t0 and time t1, the torque demand of the first axle is one half of the overall torque demand indicated by plot 202, and the torque demand of the second axle is the other half of the overall torque demand indicated by plot 202). Splitting the torque demand between the first axle and the second axle as shown by the graph 200 between time to and time t1 may increase a performance of the vehicle and reduce wear to the axles. The operation of the vehicle between time to and time t1 occurs without a shift event (e.g., the vehicle may be operating at coasting speeds, without adjustment of the shift settings of the axles).

At time t1, however, the controller determines that a shift condition has been satisfied. For example, the controller may determine that the speed of the vehicle has exceeded a threshold speed at which adjusting the shift setting of the first axle and the second axle may increase vehicle performance (e.g., increased torque at the wheels of the vehicle). As a result, at time t1, the controller commands a shift event of the tandem axle assembly. At the initiation of the shift event, the controller adjusts the torque demand of the first axle and the torque demand of the second axle concurrently. In particular, in the example shown, the controller determines that adjusting the shift setting of the first axle prior to adjusting the shift setting of the second axle is preferred, based on the vehicle operating conditions. As a result, between time t1 and time t2, the controller commands the torque demand of the second axle to increase, as indicated by plot 210, and the controller concurrently commands the torque demand of the first axle to decrease, as indicated by plot 218. The torque demand of the first axle and the torque demand of the second axle are adjusted at an equal rate between time t1 and time t2 in the example shown. In particular, the rate of increase of the torque demand of the second axle indicated by plot 210 is equal to the rate of decrease of the torque demand of the first axle indicated by plot 218 between time t1 and time t2.

At time t2, the torque demand of the first axle, indicated by plot 218, is approximately equal to a clutch disengagement torque indicated by threshold 221, and the torque demand of the second axle, as indicated by plot 212, is approximately equal to the overall torque demand indicated by the plot 204 minus an amount of torque demand equal to the clutch disengagement torque. The clutch disengagement torque may be a pre-determined torque value based on theoretical or empirical system drag compensation calculations, inertia calculations, etc., including adjustments based on environmental conditions such as temperature. As one example, the clutch disengagement torque may be calculated by the controller as a function of atmospheric temperature and/or vehicle temperature. As another example, the clutch disengagement torque may be a torque value stored in a lookup table in a memory of the controller, where an input of the lookup table may be vehicle temperature and/or atmospheric temperature, and an output of the lookup table may be the clutch disengagement torque.

Between time t2 and time t3, the torque demand of the first axle is oscillated around the clutch disengagement torque as indicated by plot 220. Parameters of the oscillation of the torque demand, such as the amplitude, period, etc. may be based on empirical test data (e.g., the parameters of the oscillation may be stored in a memory of the controller, with the parameters being pre-determined for various vehicle operating conditions). In some examples, a deviation of the torque demand of the first axle from the clutch disengagement torque during the oscillation of the torque demand may be between 10-20%. In other examples, the deviation of the torque demand of the first axle from the clutch disengagement torque during the oscillation of the torque demand may be between 20%-30%. Other examples are possible. By oscillating the torque demand as shown, the clutch coupled to the first axle may more easily disengage, which may increase a speed of shifting and reduce an amount of force applied by an actuator of the clutch to adjust the clutch between engagement and disengagement with the first axle.

Further, between time t2 and time t3, the torque demand of the second axle may be adjusted such that throughout the oscillation of the torque demand of the first axle, the torque demand of the second axle is oscillated in an opposite manner. For example, during the oscillation of the torque demand of the first axle, as the torque demand of the first axle increases, the torque demand of the second axle decreases, with a magnitude of a rate of increase of the torque demand of the first axle being equal to a magnitude of a rate of decrease of the torque demand of the second axle. Similarly, during the oscillation of the torque demand of the first axle, as the torque demand of the first axle decreases, the torque demand of the second axle increases, with a magnitude of a rate of decrease of the torque demand of the first axle being equal to a magnitude of a rate of increase of the torque demand of the second axle. In this way, throughout the oscillation of the torque demand of the first axle, an overall torque demand (e.g., a sum of the torque demand of the first axle and the torque demand of the second axle) of the vehicle may be maintained at an approximately constant value, which may increase driver comfort and/or vehicle responsiveness.

At time t3, the clutch coupled to the first axle disengages as a result of the oscillation of the torque demand of the first axle, and the shift setting of the first axle is adjusted (e.g., the shift setting is adjusted from a first shift setting in which torque is provided through a first gearbox to the first axle at a first gear ratio, to a second shift setting in which torque is provided through the first gearbox to the first axle at a second gear ratio).

Between time t3 and time t4, the controller commands the torque demand of the second axle to decrease (as indicated by plot 214) and concurrently commands the torque demand of the first axle to increase (as indicated by plot 222). Increasing the torque demand of the first axle may include increasing an energization of a first electric motor configured to provide torque to the first axle through the first gearbox, and decreasing the torque demand of the second axle may include decreasing an energization of a second electric motor configured to provide torque to the second axle through a second gearbox. The first electric motor and second electric motor may be similar to, or the same as, those described above with reference to FIG. 1. In the example shown, a magnitude of the rate at which the torque demand of the first axle increases between time t3 and time t4 is equal to a magnitude of the rate at which the torque demand of the second axle decreases between time t3 and time t4. The shift setting of the second axle may be adjusted following the adjustment of the shift setting of the first axle. In some examples, the adjustment of the shift setting of the second axle may occur between time t2 and time t3 and may occur automatically responsive to the adjustment of the shift setting of the first axle (e.g., the controller may determine that the adjustment of the shift setting of the first axle has completed, and may initiate adjustment of the shift setting of the second axle responsive to the determination that the adjustment of the shift setting of the first axle has completed).

At time t4 and onward, the overall torque demand of the tandem axle assembly, indicated by plot 206, is satisfied by equal contribution from each of the first axle and the second axle. In particular, the torque demand of the first axle is equal to the torque demand of the second axle, as indicated by plot 216, and the sum of the torque demand of the first axle and the torque demand of the second axle is equal to the overall torque demand (e.g., total torque demand). Due to the controller adjusting the torque demand of each axle throughout the shift event as described above, the overall torque demand is maintained throughout the entire shift event and the combined torque output of the first axle and the second axle is equal to the overall torque demand throughout the entire shift event. As a result, interruption of torque output of the tandem axle due to shifting may be reduced or eliminated, which may result in increased vehicle performance, increased driver comfort, reduced component wear, etc.

Referring to FIG. 3, another example vehicle operating sequence is illustrated by graph 300. The sequence of FIG. 3 may be provided via the systems of FIG. 1 in cooperation with the methods of FIGS. 5-6. The plots shown in FIG. 3 are time aligned and they occur at a same time. The vertical lines at times t0, t1, t2, and t3 represent times of interest in the sequence. The two curved vertical marks located centrally to the graph 300 along the horizontal axes represent a break in time and the break may be long or short in time duration.

The graph 300 includes a first section 302 illustrating total torque demand of the vehicle, second section 304 illustrating a torque demand of a first axle of a tandem axle assembly of the vehicle, section 306 illustrating a torque demand of a second axle the tandem axle assembly of the vehicle, section 308 illustrating a gear engagement condition of a first gearbox of the vehicle, and section 310 illustrating a gear engagement condition of a second gearbox of the vehicle. Torque may be provided through the first gearbox of the vehicle to the first axle of the tandem axle assembly during conditions in which a first clutch coupling the first gearbox to the first axle is engaged with the first axle, and torque may be provided through the second gearbox of the vehicle to the second axle of the tandem axle assembly during conditions in which a second clutch coupling the second gearbox to the second axle is engaged with the second axle.

The operating sequence shown by FIG. 3 may occur during operation of the vehicle 121 shown by FIG. 1 and described above. Further, the components described herein with reference to FIG. 3 may be similar to, or the same as, the components described above with reference to FIG. 1. For example, the first gearbox and the second gearbox may be similar to, or the same as, the first gearbox 150 and the second gearbox 152, respectively, described above with reference to FIG. 1. The first clutch and the second clutch may be similar to, or the same as, the first clutch 161 and the second clutch 163, respectively, described above with reference to FIG. 1.

Between time t0 and time t1, the total torque demand of the vehicle is maintained at an approximately constant value as indicated by plot 312, with the total torque demand split between the first axle and the second axle. In particular, the torque demand of the first axle, as indicated by plot 314, is maintained at an approximately constant value, and the torque demand of the second axle, as indicated by plot 316, is maintained at an approximately constant value, with the value of the torque demand the first axle being equal to the value of the torque demand of the second axle. The torque demand of the first axle and the torque demand of the second axle between time t0 and time t1 are each shown as being half of the value of the total torque demand. Further, between time t0 and time t1, the first gearbox is maintained with a first gear engagement as indicated by plot 318, and the second gearbox is maintained with a first gear engagement as indicated by plot 320. The first gear engagement of the first gearbox refers to engagement (e.g., meshing) of a first set of gears within the first gearbox that provides a torque output of the first gearbox at a first gear ratio of the first gearbox, and the first gear engagement of the second gearbox refers to engagement of a first set of gears within the second gearbox that provides a torque output of the second gearbox at a first gear ratio of the second gearbox. The first gear ratio of the first gearbox may be the same as (e.g., equal to) the first gear ratio of the second gearbox. During conditions in which the first gearbox is operating with the first gear engagement of the first gearbox, torque may be provided through the first gearbox to the first axle using the first gear ratio of the first gearbox, and the first axle may be referred to as operating with a first shift setting. During conditions in which the second gearbox is operating with the first gear engagement of the second gearbox, torque may be provided through the second gearbox to the second axle using the first gear ratio of the second gearbox, and the second axle may be referred to as operating with a first shift setting. Therefore, during conditions in which the first axle is operating with the first shift setting and the second axle is operating with the first shift setting, torque may be provided to each of the first axle and the second axle by the respective gearboxes operating with an equal gear ratio.

At time t1, the total torque demand of the vehicle begins to increase, as indicated by plot 312. Because the total torque demand is split between the first axle and the second axle as described above, at time t1 the torque demand of the first axle begins to increase and the torque demand of the second axle begins to increase. The rate of increase of the torque demand of the first axle is equal to the rate of increase of the torque demand of the second axle between time t1 and time t2. The first gearbox is maintained with the first gear engagement and the second gearbox is maintained with the first gear engagement between time t1 and time t2.

At time t2, a shift condition of the vehicle is satisfied, as indicated by the total torque demand shown by plot 312 transitioning above a threshold total torque demand 330. As a result, the electronic controller of the vehicle, which may be similar to, or the same as, the electronic controller 144 described above with reference to FIG. 1, commands adjustment of the shift setting of the first axle. The adjustment of the shift setting of the first axle includes transitioning the shift setting from the first shift setting described above, in which the first axle is provided torque through the first gearbox while the first gearbox is operating with the first gear ratio, to a second shift setting in which the first axle is provided torque through the first gearbox while the first gearbox is operating with a second gear ratio. The second gear ratio is different than the first gear ratio. For example, while the first gearbox is operating with the second gear ratio, a second set of gears within the first gearbox may be engaged (e.g., meshed together) and the first set of gears within the first gearbox may be disengaged (e.g., not meshed together) such that torque is output by the first gearbox using the second gear ratio.

During the transition between operating the first axle with the first shift setting to operating the first axle with the second shift setting, the controller adjusts the torque demand of each of the first axle and the second axle. In particular, following initiation of the shift event (e.g., the event during which the first axle transitions from operating with the first shift setting to operating with the second shift setting), the controller increases the torque demand of the second axle and decreases the torque demand of the first axle, as described further below with reference to FIG. 4. Throughout the shift event, the controller maintains the sum of the torque demand of the first axle and the torque demand of the second axle equal to the total torque demand. However, the torque demand of the first axle and the torque demand of the second axle are not equal throughout the entirety of the shift event. By increasing the torque demand of the second axle and decreasing the torque demand of the first axle, the second axle may provide the majority of the torque for propulsion of the vehicle as the first axle is transitioned from the first shift setting to the second shift setting. As a result, a likelihood of interruption of torque provided for propulsion of the vehicle may be reduced, and driver comfort and vehicle performance may be increased. Following the adjustment of the first axle from the first shift setting to the second shift setting, the second axle may be adjusted from the first shift setting to the second shift setting such that both of the first axle and the second axle operate at the second shift setting (e.g., the first axle and the second axle may be provided torque from the respective coupled gearboxes operating with the second gear ratio). In this way, the first axle and the second axle may be adjusted from operating with the first shift setting to operating with the second shift setting without reducing the total torque provided for propulsion of the vehicle.

Following the shift event initiated at time t2, the total torque demand continues to increase and then is maintained at a relatively constant value as indicated by plot 312, while the first axle and the second axle are operated with the second shift setting as indicated by plot 318 and plot 320, respectively. Further, following the shift event initiated at time t2, the torque demand of the first axle as indicated by plot 314 is equal to the torque demand of the second axle as indicated by plot 316. The vehicle conditions may be maintained until time t3, described below.

Prior to time t3, the total torque demand decreases from the approximately constant value toward the threshold total torque demand 330. As the torque demand of the first axle and the torque demand of the second axle are equal immediately prior to time t3, the torque demand of the first axle and the torque demand of the second axle each decrease at a same rate as the total torque demand decreases, and the first axle and the second axle are each operated with the second shift setting.

At time t3, the total torque demand transitions below the threshold total torque demand 330. As a result of the total torque demand transitioning below the threshold total torque demand 330, the controller determines that a shift condition of the vehicle has been satisfied and the controller commands adjustment of the shift setting of the first axle. The adjustment of the shift setting of the first axle includes transitioning the shift setting from the second shift setting described above, in which the first axle is provided torque through the first gearbox while the first gearbox is operating with the second gear ratio, to the first shift setting in which the first axle is provided torque through the first gearbox while the first gearbox is operating with the first gear ratio.

During the transition between operating the first axle with the second shift setting to operating the first axle with the first shift setting, the controller adjusts the torque demand of each of the first axle and the second axle. In particular, following initiation of the shift event at time t3 (e.g., the event during which the first axle transitions from operating with the second shift setting to operating with the first shift setting), the controller increases the torque demand of the second axle and decreases the torque demand of the first axle, as described further below with reference to FIG. 4. Throughout the shift event, the controller maintains the sum of the torque demand of the first axle and the torque demand of the second axle equal to the total torque demand. However, the torque demand of the first axle and the torque demand of the second axle are not equal throughout the entirety of the shift event. By increasing the torque demand of the second axle and decreasing the torque demand of the first axle, the second axle may provide the majority of the torque for propulsion of the vehicle as the first axle is transitioned from the second shift setting to the first shift setting. As a result, a likelihood of interruption of torque provided for propulsion of the vehicle may be reduced, and driver comfort and vehicle performance may be increased. Following the adjustment of the first axle from the second shift setting to the first shift setting, the second axle may be adjusted from the second shift setting to the first shift setting such that both of the first axle and the second axle operate at the first shift setting (e.g., the first axle and the second axle may be provided torque from the respective coupled gearboxes operating with the first gear ratio). In this way, the first axle and the second axle may be adjusted from operating with the second shift setting to operating with the first shift setting without reducing the total torque provided for propulsion of the vehicle.

Following completion of the shift event initiated at time t3, the total torque demand decreases and then is maintained at an approximately constant value. Further, following completion of the shift event initiated at time t3, the torque demand of the first axle may be equal to the torque demand of the second axle, and the sum of the torque demand of the first axle and the torque demand of the second axle is equal to the total torque demand. As the first axle is operated with the first shift setting and the second axle is operated with the first shift setting, the first gearbox is operated using the first gear engagement of the first gearbox as indicated by plot 318 and the second gearbox is operated using first gear engagement of the second gearbox as indicated by plot 320.

Referring to FIG. 4, various enlarged views of portions of the graph 300 of FIG. 3 are shown. In particular, FIG. 4 shows inset 400, inset 402, inset 404, and inset 406, where inset 400 shows an enlarged view of the portion of graph 300 indicated by marker 326 in FIG. 3, inset 402 shows an enlarged view of the portion of graph 300 indicated by marker 322 in FIG. 3, inset 404 shows an enlarged view of the portion of graph 300 indicated by marker 328 in FIG. 3, and inset 406 shows an enlarged view of the portion of graph 300 indicated by marker 324 in FIG. 3.

The portion of the graph 300 shown by inset 400 includes plot 316 indicating the torque demand of the second axle as described above, and the portion of the graph 300 shown by inset 402 includes plot 314 indicating the torque demand of the first axle as described above. The portions of the plot 316 and the plot 314 shown by the inset 400 and the inset 402, respectively, show the first shift event illustrated by the graph 300 (e.g., the shift event in which the first axle is adjusted from operating with the first shift setting to operating with the second shift setting, where, while the first axle operates with the first shift setting, the first gearbox operates with the first gear engagement, and while the first axle operates with the second shift setting, the first gearbox operates with the second gear engagement, as described above with reference to FIG. 3). The inset 400 includes vertical axis 442 and vertical axis 444, where the vertical axis 442 is arranged at a time of initiation of the first shift event, and the vertical axis 444 is arranged at the time of completion of adjustment of the shift setting of the first axle during the first shift event. The inset 402 includes vertical axis 446 and vertical axis 448, with the vertical axis 446 being coaxial with the vertical axis 442 shown by the inset 400, and with the vertical axis 448 being coaxial with the vertical axis 444 shown by inset 400. In particular, vertical axis 442 shown by inset 400 and vertical axis 446 shown by inset 402 indicate a same moment in time (e.g., a same time on the horizontal axis of graph 300, such as time t2 shown by FIG. 3), and vertical axis 444 shown by inset 400 and vertical axis 448 shown by inset 402 indicate a same moment in time (different than the moment indicated by vertical axis 442 and vertical axis 446).

The portion of the graph 300 shown by inset 404 includes plot 316 indicating the torque demand of the second axle as described above, and the portion of the graph 300 shown by inset 406 includes plot 314 indicating the torque demand of the first axle as described above. The portions of the plot 316 and the plot 314 shown by the inset 404 and the inset 406, respectively, show the second shift event illustrated by the graph 300 (e.g., the shift event in which the first axle is adjusted from operating with the second shift setting to operating with the first shift setting). The inset 404 includes vertical axis 450 and vertical axis 452, where the vertical axis 450 is arranged at a time of initiation of the second shift event, and the vertical axis 452 is arranged at the time of completion of adjustment of the shift setting of the first axle during the second shift event. The inset 406 includes vertical axis 454 and vertical axis 456, with the vertical axis 454 being coaxial with the vertical axis 450 shown by the inset 404, and with the vertical axis 456 being coaxial with the vertical axis 452 shown by inset 404. In particular, vertical axis 450 shown by inset 404 and vertical axis 454 shown by inset 406 indicate a same moment in time (e.g., a same time on the horizontal axis of graph 300, such as time t3 shown by FIG. 3), and vertical axis 452 shown by inset 404 and vertical axis 456 shown by inset 406 indicate a same moment in time (different than the moment indicated by vertical axis 450 and vertical axis 454).

In the inset 400, the total torque demand of the vehicle is indicated by plot 436. Plot 436 may be the same as plot 312 shown by FIG. 3 and described above and is shown superimposed with plot 316 for purposes of comparison. At the time indicated by the vertical axis 442, the first shift event is initiated by the controller responsive to the vehicle operating conditions (e.g., responsive to the total torque demand of the vehicle, as described above with reference FIG. 3). As a result, the controller commands the torque demand of the second axle to increase, as indicated by portion 408 of plot 316. The controller increases the torque demand of the second axle until the torque demand of the second axle is approximately equal to the total torque demand of the vehicle indicated by plot 436. Concurrently, the controller lowers the torque demand of the first axle until the torque demand of the first axle is approximately zero, as indicated by portion 409 of plot 314 shown by inset 402. In particular, the controller concurrently increases the torque demand of the second axle and decreases the torque demand of the first axle at the time indicated by vertical axis 442 of inset 400 and vertical axis 446 of inset 402. A magnitude of the rate of increase of the torque demand of the second axle may be equal to a magnitude of the rate of decrease of the torque demand of the first axle, in particular between the time indicated by vertical axis 442 and vertical axis 446 and the time at which the torque demand of the second axle is equal to the total torque demand of the vehicle (e.g., the time indicated by vertical axis 407 shown by inset 400 and vertical axis 417 shown by inset 402, where the vertical axis 407 and the vertical axis 417 are arranged at a same position along the horizontal axis of the graph 300 and indicate the same moment in time).

Throughout an entirety of the duration between the time indicated by the vertical axis 407 and the time indicated by vertical axis 411 shown by inset 400, the torque demand of the second axle is maintained around the total torque demand indicated by plot 436 (e.g., within a range of torque demand values centered around the total torque demand, including torque demand values slightly above or slightly below the total torque demand, where the range may be a pre-determined range based on a difference between an upper value of the oscillation of the torque demand of the first axle and a lower value of the oscillation of the torque demand of the first axle). Concurrently, throughout an entirety of the duration between the time indicated by vertical axis 417 and the time indicated by the vertical axis 419 shown by inset 402, the controller commands the torque demand of the first axle to oscillate around a clutch disengagement torque (e.g., with the oscillation having the upper value and lower value around the clutch disengagement torque, similar to the example described above with reference to FIG. 2). In some examples, the torque demand of the second axle may be oscillated in an opposite manner around the total torque demand relative to the oscillation of the torque demand of the first axle around the clutch disengagement torque, similar to the example described above with reference to FIG. 2. The entirety of the duration between the time indicated by the vertical axis 407 and the vertical axis 411 occurs concurrently with the entirety of the duration between the time indicated by the vertical axis 417 and the vertical axis 419 (e.g., the durations have the same length, start concurrently, and end concurrently).

FIG. 4 includes inset 420 showing an enlarged view of portion 416 included within inset 402. In particular, the inset 420 shows an enlarged view of the plot 314 indicating the torque demand of the first axle throughout the duration in which the torque demand of the first axle is oscillated as described above. The inset 420 includes a horizontal line 440 indicating a torque demand of zero. The inset 420 additionally includes horizontal axis 429 indicating the clutch disengagement torque, horizontal axis 428 indicating an example upper value of the oscillation of the torque demand of the first axle, and horizontal axis 430 indicating an example lower value of the oscillation of the torque demand of the first axle. Portion 424 of plot 314 shows the oscillation of the torque demand of the first axle. Although the example upper value and example lower value of the oscillation of the torque demand are indicated by the horizontal axis 428 and horizontal axis 430 respectively, in some embodiments the upper value in the lower value of the oscillation of the torque demand of the first axle may be different than the examples shown by FIG. 4. The upper value and the lower value the oscillation of the torque demand of the first axle may be within a range of five percent of the clutch disengagement torque indicated by horizontal axis 429, in some embodiments.

In some embodiments, a frequency, amplitude, or period of the oscillation of the torque demand of the first axle may be adjusted by the controller based on parameters of the system and system components (e.g., gearboxes). The parameters may include operating parameters of the first axle such as inertia, drag, oil viscosity, gear tooth backrake configuration, rotational speed, temperature, PID controller gains, load, gradient, gear ratio, etc.

The controller may command the oscillation of the torque demand of the first axle to be performed for a pre-determined duration, in some embodiments. In other embodiments, the controller may command the oscillation of the torque demand of the first axle to be performed until the controller determines that a condition has been satisfied. As one example, the controller may command oscillation of the torque demand of the first axle until the controller determines that a clutch connecting the first gearbox with the first axle has adjusted from an engaged condition to a disengaged condition (e.g., a condition in which torque is not transmitted from the first gearbox to the first axle through the clutch). For example, as described above, the clutch may be configured such that force applied to the clutch maintains engagement of the clutch with the first axle. As the amount of torque applied to the first axle through the clutch increases, the force applied to maintain engagement of the clutch with the first axle may also increase. However, during shift events, residual forces applied to the clutch by other components and/or features of the system may increase a difficulty of disengaging the clutch from the first axle. Residual forces may include bearing drag, lubricant viscosity, and/or churning of lubricant at the clutch, which may result in residual torque applied to the clutch even during conditions in which torque is not provided to the clutch through the gearbox. As a result, undesired engagement of the clutch with the first axle may occur during conditions in which the clutch is commanded to disengage from the first axle.

However, by oscillating the torque demand of the first axle around the clutch disengagement torque during a shift event as described above, the clutch may more easily be disengaged from the first axle in order to adjust the shift setting of the first axle. In particular, oscillating the torque demand of the first axle around the clutch disengagement torque during the shift event may increase a likelihood that an actuator configured to disengage the clutch from the first axle responsive to commands received by the controller may overcome the residual forces and disengage the clutch with reduced actuator force. As a result, a responsiveness of the clutch and/or clutch actuator may be increased, and vehicle performance may be increased.

The clutch disengagement torque may be a pre-determined torque value based on a configuration of the vehicle and the components within the vehicle. For example, the clutch disengagement torque may be based on a size of the actuator of the clutch, anticipated residual forces that may apply to the clutch during conditions in which the clutch is commanded to disengage (e.g., where the residual forces may be a function of lubrication viscosity, lubrication amount, bearing type, etc.), or other parameters such as vehicle speed (with different vehicle speeds resulting in different amounts of drag), vehicle momentum (with different vehicle momentums resulting in different output inertias), inertia of propulsion, etc. As one example, the clutch disengagement torque may be 100 Nm, and during conditions in which the torque applied at the clutch is oscillated around the clutch disengagement torque, the upper value of the oscillation may be 150 Nm and the lower value of the oscillation may be 50 Nm. Other examples are possible. In some examples, the upper value of the oscillation may be offset from the clutch disengagement torque by a different amount than the lower value of the oscillation.

Inset 404 and inset 406 of FIG. 4 show adjustment of the torque demand of the second axle and adjustment of the torque demand of the first axle, respectively, during a second shift event of the vehicle. The second shift event occurs after the first shift event, and during the second shift event, the first axle and the second axle are adjusted from operating with the second shift setting to operating with the first shift setting. The inset 404 includes vertical axis 450 and the vertical axis 452, and the inset 406 includes vertical axis 454 and vertical axis 456. The vertical axis 450 of inset 404 and the vertical axis 454 of inset 406 represent a same moment in time and may be arranged at a same location along the horizontal axis of the graph 300 shown by FIG. 3. The vertical axis 452 of inset 404 and the vertical axis 456 of inset 406 also represent a same moment in time and may be arranged at a same location along the horizontal axis of the graph 300 shown by FIG. 3.

At the time indicated by the vertical axis 450 of inset 404 in the vertical axis 454 of inset 406, the second shift event is initiated responsive to a determination by the controller that a shift condition has been satisfied. The shift condition may be a determination by the controller that the total torque demand of the tandem axle assembly has transitioned below a threshold torque demand, in one example. As a result, the controller increases the torque demand of the second axle as indicated by portion 412 of plot 316 shown by inset 404 until the torque demand of the second axle is approximately equal to the total torque demand of the tandem axle assembly, where the total torque demand of the tandem axle assembly is indicated by plot 438. The plot 438 may be the same as the plot 312 shown by FIG. 3 and described above. Concurrently, while the controller increases the torque demand of the second axle, the controller decreases the torque demand of the first axle as indicated by portion 414 of plot 314 shown by inset 406. The controller may decrease the torque demand of the first axle until the torque demand of the first axle is approximately equal to the clutch disengagement torque.

As shown by inset 422 showing an enlarged view of portion 418 included within inset 406, the controller commands oscillation of the torque demand of the first axle around the clutch disengagement torque while the torque demand of the second axle is maintained at values within a range of the total torque demand of the tandem axle assembly. For example, the torque demand of the second axle may be oscillated in a manner opposite to the oscillation of the torque demand of the first axle, similar to the example described above with reference to FIG. 2, with a difference between an upper value and a lower value of the oscillation of the torque demand of the second axle around the total torque demand being equal to a difference between an upper value and a lower value of the oscillation of the torque demand of the first axle around the clutch disengagement torque. The oscillation of the torque demand of the first axle is indicated by portion 426 of plot 314, shown enlarged by inset 422. By oscillating the torque demand of the first axle around the clutch disengagement torque, the clutch may be more easily disengaged from the first axle, similar to the examples described above. Following the disengagement of the clutch from the first axle, the gear engagement of the gearbox configured to provide torque to the first axle may be adjusted by the controller from the second gear engagement to the first gear engagement, and the controller may command re-engagement of the clutch with the first axle following the adjustment of the gear engagement. As a result, the first axle is transitioned from operating with the second shift setting to operating with the first shift setting. The controller then commands a concurrent increase to the torque demand of the first axle and a concurrent decrease to the torque demand of the second axle until the torque demand of the first axle is equal to the torque demand of the second axle. The controller may then command adjustment of the second axle from the second shift setting to the first shift setting. By controlling operation of the first axle and the second axle as described above, a speed of adjusting the shift setting of the first axle and the second axle may be increased, which may increase vehicle performance.

Referring to FIG. 5, a method for operating a tandem axle assembly is shown. The method of FIG. 5 may be included in the systems of FIG. 1 as executable instructions stored in non-transitory memory of the electronic controller. Further still, at least portions of the method of FIG. 5 may be actions performed in the physical world by the electronic controller operating one or more actuators, for example.

The vehicle described with reference to the methods of FIGS. 5-6 may be similar to, or the same as, the vehicle 121 described above with reference to FIG. 1. Further, components described with reference to the methods of FIGS. 5-6 may be similar to, or the same as, the components described above with reference to FIG. 1. For example, the tandem axle assembly described herein with reference to FIGS. 5-6 may be similar to, or the same as, the tandem axle assembly 160 described above with reference to FIG. 1. The first axle and the second axle described herein with reference to FIGS. 5-6 may be similar to, or the same as, the first axle 175 and the second axle 190, respectively, described above with reference to FIG. 1.

At step 502, the method includes estimating and/or measuring vehicle operating conditions. The vehicle operating conditions may include vehicle speed, total torque output of the tandem axle assembly, torque output of a first axle of the tandem axle assembly.

The method continues from step 502 to step 504 where the method includes determining whether a shift condition has been satisfied. The shift condition may be based on the vehicle operating conditions such as one or more of vehicle speed, vehicle load, tandem axle assembly torque output, etc. The determination of whether a shift condition has been satisfied may be performed by the electronic controller based on the vehicle operating conditions. As one example, the controller may determine whether a shift condition has been satisfied based on whether a torque output of the tandem axle assembly has transitioned above a threshold torque output. Responsive to determining that the torque output of the tandem axle assembly has transitioned above the threshold torque output, the controller may determine that the shift condition has been satisfied. As another example, the controller may determine whether the shift condition has been satisfied based on the vehicle speed. Responsive to determining that the vehicle speed has transitioned above a threshold vehicle speed, the controller may determine that the shift condition has been satisfied. Other examples are possible.

If the shift condition has not been satisfied at step 504, the method continues from step 504 to step 506 where the method includes maintaining vehicle operating conditions. Maintaining the vehicle operating conditions may include maintaining the shift setting of each axle of the tandem axle assembly, maintaining vehicle speed, maintaining torque demand and torque output of each axle of the tandem axle assembly, maintaining an amount of energization of electric motors driving the axles of the tandem axle assembly, etc.

However, if the shift condition has been satisfied at step 504, the method continues from step 504 to step 508 where the method includes commanding transition of the tandem axle assembly including the first axle and the second axle from a first shift setting to a second shift setting. For example, the first shift setting and the second shift setting may be similar to the first shift setting and the second shift setting described above with reference to FIGS. 3-4. In particular, during conditions in which the first axle is operated with the first shift setting, a first gearbox configured to provide torque to the first axle may be operated with a first gear engagement of the first gearbox, and during conditions in which the second axle is operated with the first shift setting, a second gearbox configured to provide torque to the second axle may be operated with the first gear engagement of the second gearbox, similar to the examples described above. Responsive to determining that the shift condition has been satisfied, the controller commands the first axle to adjust from the first shift setting to the second shift setting. The controller may additionally command the second axle to adjust from the first shift setting to the second shift setting. Commanding the first axle to adjust from the first shift setting to the second shift setting may include transmitting signals (e.g., electronic signals) from the electronic controller to an actuator of the clutch connecting the first gearbox to the first axle, and commanding the second axle to adjust from the first shift setting to the second shift setting may include transmitted signals from the electronic controller to an actuator of a clutch connecting the second gearbox to the second axle.

The method continues from step 508 to step 510 where the method includes transitioning the first axle between the shift settings by controlling torque applied to an input connection of the first axle and controlling torque applied to an input connection of the second axle. The input connection of the first axle may be the clutch connecting the first axle to the first gearbox, and the input connection of the second axle may be the clutch connecting the second axle to the second gearbox. The transition of the first axle from the first shift setting to the second shift setting includes decreasing the torque demand of the first axle, increasing the torque demand of the second axle, and oscillating the torque demand of the first axle around a clutch disengagement torque, as described in further detail below with reference to FIG. 6.

The method continues from step 510 to step 512 where the method includes transitioning the second axle of the tandem axle assembly between the shift settings. Transitioning the second axle of the tandem axle assembly between the shift settings may include adjusting the second axle from operating with a first shift setting to operating with a second shift setting. For example, following the transition of the first axle from the first shift setting to the second shift setting, the controller may transition the second axle from the first shift setting to the second shift setting by lowering the torque demand of the second axle and commanding oscillation of the torque demand of the second axle around a clutch disengagement torque while the torque demand of the first axle is increased.

Referring to FIG. 6, a method 600 for transitioning a first axle between shift settings by controlling torque applied to an input connection of the first axle and torque applied to an input connection of a second axle is shown. The method 600 may be implemented as step 510 of method 500 described above with reference to FIG. 5. In particular, the first axle, input connection of the first axle, second axle, and input connection of the second axle may be the same as the first axle, input connection of the first axle, second axle, and input connection of the second axle described above with reference to FIG. 5. Controlling the torque applied to the input connection of the first axle may refer to controlling the torque demand of the first axle, and controlling the torque applied to the input connection of the second axle may refer to controlling the torque demand of the second axle.

At step 602, the method includes adjusting torque applied at the input connection of the first axle based on a clutch disengagement torque. The clutch disengagement torque may be the same clutch disengagement torque described above with reference to FIG. 5. The input connection of the first axle may be a clutch connecting the first axle with a first gearbox, similar to the examples described above.

The method at step 602 includes, at step 604, reducing torque applied at the input connection of the first axle. Reducing the torque applied at the input connection of the first axle may include commanding a reduction of the torque demand of the first axle via the electronic controller. Commanding the reduction of the torque demand of the first axle via the electronic controller may include transmitting signals (e.g., electronic signals) from the electronic controller to a first electric motor (e.g., traction motor) to adjust (e.g., reduce) energization of the first electric motor and reduce a torque output of the first electric motor. The first electric motor may be configured to provide torque to the first axle through a first gearbox.

The controller may reduce the torque demand of the first axle at a relatively constant rate until the torque demand of the first axle is approximately equal to the clutch disengagement torque. Reducing the torque demand of the first axle at the relatively constant rate may be similar to reduction of the torque demand of the first axle shown by plot 314 between vertical axis 446 and vertical axis 417 of inset 402 of FIG. 4, for example.

The method continues from step 602 to step 606 where the method includes adjusting torque applied at the input connection of the second axle based on the torque applied at the input connection of the first axle. The input connection of the second axle may be a clutch connecting the second axle with a second gearbox, similar to the examples described above.

The method at step 606 includes, at step 608, increasing torque applied at the input connection of the second axle by an amount equal to the amount by which the torque applied at the input connection of the first axle is reduced. The increasing of the torque applied at the input connection of the second axle may occur concurrently with the reducing of the torque applied at the input connection of the first axle. Increasing the torque applied at the input connection of the second axle may include commanding an increase of the torque demand of the second axle via the electronic controller. Commanding the increase of the torque demand of the second axle via the electronic controller may include transmitting signals (e.g., electronic signals) from the electronic controller to a second electric motor (e.g., traction motor) to adjust (e.g., increase) energization of the second electric motor and increase a torque output of the second electric motor. The second electric motor may be configured to provide torque to the second axle through a second gearbox.

The method continues from step 606 to step 610 where the method includes oscillating the reduced torque applied at the first axle around the clutch disengagement torque. Oscillating the reduced torque applied at the first axle around the clutch disengagement torque may include oscillating the torque demand of the first axle around the clutch disengagement torque.

The method at step 610 may include, at step 612, adjusting energization of a first electric traction motor coupled to the clutch. For example, oscillating the torque demand of the first axle around the clutch disengagement torque may include oscillating an energization of the first electric traction motor configured to provide torque to the first axle through the first gearbox. As one example, the controller may oscillate the energization of the first electric traction motor to oscillate the torque output by the first electric traction motor, and the oscillating torque output of the first electric traction motor may be provided to the first axle via the first gearbox.

The method continues from step 610 to step 614 where the method includes disengaging the clutch coupled to the first axle during the oscillation of the reduced torque applied at the first axle, adjusting gearbox gear engagement, and re-engaging the clutch. As described above, the clutch may be the input connection of the first axle, and oscillating the torque applied at the input connection may refer to oscillating the torque applied at the clutch. The oscillation of the torque applied at the first axle (e.g., oscillation of the torque demand of the first axle) around the clutch disengagement torque may increase an case of disengaging the clutch from the first axle in order to adjust the shift setting of the first axle. For example, an actuator of the clutch connecting the first axle with the first gearbox may disengage the clutch from the first axle with a reduced amount of force during the conditions in which the torque applied at the first axle is oscillated around the clutch disengagement force. Following the disengagement of the clutch during the oscillation of the torque at the first axle, the gear engagement of the first gearbox may be adjusted from a first gear engagement corresponding to a first shift setting of the first axle to a second gear engagement corresponding to a second shift setting of the first axle. The controller may then command re-engagement of the clutch in order to operate the first axle with the second shift setting.

As described above, residual forces (e.g., bearing drag, lubrication churning, etc.) may result in undesired engagement of the clutch with the first axle during conditions in which the controller commands disengagement of the clutch from the first axle. By oscillating the torque around the clutch disengagement torque, the actuator of the clutch may more easily overcome the residual forces in order to disengage the clutch when commanded by the controller. As a result, a speed of adjustment of the shift setting of the first axle may be increased, which may increase vehicle performance and driver comfort. Further, by increasing the torque applied at the input connection of the second axle concurrently while the torque applied at the input connection of the first axle is reduced, the total torque demand of the vehicle (and total torque output of the tandem axle assembly) may be maintained throughout an entire duration of the transition of the first axle from the first shift setting to the second shift setting, which may also increase vehicle performance and driver comfort by reducing a likelihood of interruption of torque provided to the wheels of the vehicle for propulsion of the vehicle.

The method continues from step 614 to step 616 where the method includes applying an equal amount of torque at the input connection of the first axle and the input connection of the second axle. Following the transition of the first axle from the first shift setting to the second shift setting, the controller may increase the torque (e.g., torque demand) of the first axle and reduce the torque (e.g., torque demand) of the second axle. In this condition, the total torque demand may be split equally between the first axle and the second axle.

While various embodiments have been described above, it may be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive.

Note that the example control and estimation routines included herein can be used with various powertrain and/or vehicle system configurations. The control methods and routines disclosed herein may be stored as executable instructions in non-transitory memory and may be carried out by the control system including the controller in combination with the various sensors, actuators, and other transmission and/or vehicle hardware. Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example examples described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the vehicle and/or transmission control system, where the described actions are carried out by executing the instructions in a system including the various hardware components in combination with the electronic controller. One or more of the method steps described herein may be omitted if desired.

It will be appreciated that the configurations and routines disclosed herein are exemplary in nature, and that these specific examples are not to be considered in a limiting sense, because numerous variations are possible. For example, the above technology can be applied to powertrains that include different types of propulsion sources including different types of electric machines, internal combustion engines, and/or transmissions. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

As used herein, the terms “approximately” and “substantially” are construed to mean plus or minus five percent of the range, unless otherwise specified.

1. A method, comprising:
while transitioning a first axle of a tandem axle assembly between shift settings, adjusting torque applied at an input connection of the first axle based on a clutch disengagement torque.

2. The method of claim 1, wherein adjusting the torque applied at the input connection of the first axle based on the clutch disengagement torque includes oscillating the torque around the clutch disengagement torque.

3. The method of claim 2, further comprising adjusting a frequency, amplitude, or period of the oscillation of the torque around the clutch disengagement torque based on an operating parameter of the first axle.

4. The method of claim 2, further comprising: while oscillating the torque applied to the input connection of the first axle, oscillating torque applied to an input connection of a second axle of the tandem axle assembly by an opposite amount.

5. The method of claim 1, further comprising: while transitioning the first axle of the tandem axle assembly between shift settings, increasing torque applied at an input connection of a second axle of the tandem axle assembly.

6. The method of claim 5, wherein adjusting the torque applied at the input connection of the first axle based on the clutch disengagement torque includes reducing the torque from an initial torque to the clutch disengagement torque, and wherein increasing the torque applied at the input connection of the second axle includes increasing the torque by an amount equal to a difference between the initial torque and the clutch disengagement torque.

7. The method of claim 5, wherein decreasing the torque applied at the input connection of the first axle and increasing the torque applied at the input connection of the second axle occurs concurrently.

8. The method of claim 1, wherein adjusting the torque applied at the input connection of the first axle based on the clutch disengagement torque includes decreasing the torque applied at the input connection of the first axle by more than 50%.

9. The method of claim 1, wherein the clutch disengagement torque is a pre-determined torque value based on a force output of an actuator of a clutch.

10. A method, comprising:
during a shift event of a tandem axle assembly including a first axle and a second axle:
reducing torque applied at the first axle while concurrently increasing torque applied at the second axle; and
oscillating the reduced torque applied at the first axle while maintaining the increased torque applied at the second axle.

11. The method of claim 10, further comprising: disengaging a clutch coupled to the first axle during the oscillation of the reduced torque applied at the first axle.

12. The method of claim 11, further comprising: during the shift event, prior to disengaging the clutch, driving the first axle via a gearbox at a first gear ratio; and, after disengaging the clutch, driving the first axle via the gearbox at a different, second gear ratio.

13. The method of claim 11, further comprising: after disengaging the clutch and during the shift event, equally increasing the torque applied at the first axle and reducing the torque applied at the second axle.

14. The method of claim 12, further comprising: after equally increasing the torque applied at the first axle and reducing the torque applied at the second axle, during the shift event, disengaging a clutch coupled to the second axle.

15. The method of claim 14, wherein each of reducing the torque applied at the first axle and oscillating the reduced torque applied at the first axle includes adjusting energization of a first electric traction motor coupled to the clutch.

16. The method of claim 10, wherein a total torque applied at the first axle and the second axle is maintained throughout an entirety of the shift event.

17. A vehicle system, comprising:
a tandem axle assembly including a first axle and a second axle;
a first clutch engageable to couple the first axle to a first gearbox;
a second clutch engageable to couple the second axle to a second gearbox;
a controller with computer readable instructions stored on non-transitory memory that when executed, cause the controller to:
transition the first axle of the tandem axle assembly between shift settings; and
during the transition, adjust torque applied at the first clutch based on a disengagement torque of the first clutch.

18. The vehicle system of claim 17, wherein the controller further includes instructions stored on the non-transitory memory that when executed, cause the controller to:
adjust the torque applied at the first clutch based on the disengagement torque of the first clutch during the transition by oscillating the torque applied at the first clutch around the disengagement torque.

19. The vehicle system of claim 17, wherein the controller further includes instructions stored on the non-transitory memory that when executed, cause the controller to:
concurrently increase torque applied at the second clutch during the adjustment of the torque applied at the first clutch.

20. The vehicle system of claim 17, further comprising a first electric motor coupled to the first gearbox and configured to drive the first axle via the first gearbox, and a second electric motor coupled to the second gearbox and configured to drive the second axle via the second gearbox.
